(19) United States
(12) Patent Application Publication
(10) Pub. No.: US 2020/0370367 A1
(43) Pub. Date: Nov. 26, 2020

(54) Clutch Module For A Hoist Device And The Hoist Device Using The Same

(71) Applicant: Jaeheun Jung, Seoul (KR)

(72) Inventor: Jaeheun Jung, Seoul (KR)

(21) Appl. No.: 16/422,973

(22) Filed: May 25, 2019

(51) Int. Cl. E06B 9/322; E06B 9/323; E06B 9/42

(52) U.S. Cl. CPC E06B 9/322; E06B 9/42; E06B 9/323

(57) ABSTRACT

The purpose of the present invention is to provide the clutch module for the hoist device having the enhanced braking and smooth driving for producing compact, easy by using cheap materials comprising: a manual pulley; a first clutch member with a wrap spring integrally formed with the engaging portion; a clutch stator having a first spring friction surface and fixed to the bracket; a driving member including a first driving rotor and a first driving rotor to release the frictional braking force between a spring friction surface of the clutch stator and a wrap spring inner diameter of the clutch stator in the direction the body of the wrap spring as a clutch member rotates when the manual pulley rotates; Up member for increasing the frictional braking force between the clutch stator and the clutch member by pushing the engaging portion of the clutch member in a direction to the wrap spring body of the clutch member is narrowed when the rotational force of the power transmitting portion of the hoist device is transmitted; and means for preventing interference between the driving member and the pickup member; and a control unit.

### BACKGROUND OF THE INVENTION

### 1. Field of the Invention

The present invention relates to a clutch module for a hoist device and the hoist device using the same, which is descending due to the weight of various hoist devices or braking the rotation of the winding member. At the same time, it has enhanced braking and smooth operating to be used for lifting or lowering heavyweight.

As the hoist device, a pull string of a predetermined length is bound on one side end of the various shades or the supporting members. The other end is tied to the winding member. The pull string is winding or unwinding to lift or lower the laundry hanging on the support member, such as clothes dryer.

More particularly, the present invention has provided a roll/combination/triple blind as the shade. A roll blind and a shading device are for shielding and lighting. One end of a screen having a preset width and height is fixed on a rod as a winding member having a preset diameter to wind and unwind in the manner of lifting up and lowering the blind. At a lowest end of the supporting member, on end of the pulling string is tied to a plurality of slats for folding or unfolding. And the pull string is inserted into the holes formed on the plurality of slats. The upper end of the pulling string is fixed to a winding member to lift and lower the plurality of slats, one by one, to shielding and lighting, such as a Venetian blind. At the bottom of the corrugated screen, the pulling string and the supporting member are tied up, and the upper end side of the pulling string is fixed to the winding member for folding and unfolding the screen in manner of lifting or lowering the blind, such a honeycomb blind and Pleated blind.

### 2. Related Prior Art

Generally, the shade, which is a kind of hoist device installed in the indoor or outdoor, is arranged on a window frame to selectively perform the shielding and lighting through a window. There are a slat type and a screen type.

The slat type includes: i) a Venetian blind having a structural characteristics of a longitudinal slots, and arranged horizontally to perform selectively shielding and lighting while moving vertically, ii) Vertical blinds having vertical slots and arranged vertically for selectively shielding and lighting and moving laterally, and iii) a Louver type which is provided to be pivoted at a fixed position and is equipped with a plurality of louvers of an angle-adjusting type. The screen types include: i) a roll blind having a roll arranged in a horizontal direction that winds the screen for rolling up and down to perform selectively shielding and lighting, and ii) a honeycomb and Pleated blind that the corrugated fabric is folded or unfolded to perform selectively shielding and lighting.

Such an awning is usually provided with a pulling string coupled to the supporting member. Or a winding member fixed firmly to any fixed member, so that the screen itself can be wound or unwound. A support member or a plurality of slats or screens or a combination thereof forms a weight. A pulling string or a screen coupled thereto is loosely released from the winding member by gravity. An electromotive force, motor or manual power uses to pull the pulling string or the screen to take up the screen around the winding member to lift up the slat or screen at a desired certain height or rotate the predetermined angle. When the electric power or the manual power is not applied to the winding member, the winding member is braking not to rolling down due to gravity of the weight. When the electric power is applied to the winding member, the winding member is required a brake and a driving device such as a clutch (it is usually called a “clutch”).

In addition, a laundry drying rack as another kind of hoist device is installed in the indoor or outdoor. The principle of braking and driving is similar to that of the above-mentioned shade. When the electric power or manual power is not applied to the winding member, the winding member is needed to brake not to rotate descending due to the gravity of the weight. At the same time, the winding member is required a brake and driving device (hereinafter referred to as a clutch) when the power is applied to the winding member.

In addition, there are various hoist devices. However, its components and the operational relationships are as similar, each other. This fact is obvious to those skilled in the art. Therefore, further description of other hoist devices will be omitted hereinafter.

Hereinafter, the brake and the driving device of the present application enable to brake the winding member of the above hoist device brake not to rotate descending due to the gravity of the weight. When the power is applied to the winding member, the winding member enables to rotate by the driving device; it is referred to a braking and driving clutch for the hoist device, more simply referred to as a “clutch.” A shading device will be described in detail as a typical background technique in order to explain the present invention to a person skilled in the art.

For example, FIG. 1 A and FIG. 1B are a perspective view and an exploded perspective view of a typical roll shield, respectively. FIG. 10 is a perspective view of a combination blind, which is a kind of roll shield using two layers. FIG. 1D is a perspective view of a plastic bracket, which is one kind of various brackets.

FIG. 2A is an exploded perspective view showing a conventional clutch for a roll shield, FIG. 2B is an example of clutch for various roll shields. FIG. 2C is an exploded perspective view of the real photo clutch shown in FIG. 2B. FIG. 2D is an exploded perspective view of a clutch for decelerating rolls using a conventional planetary gear. FIG. 3 is a sectional view of a conventional spring clutch.

First of all, as shown in FIG. 1A to FIG. 2D, a head rail (10) is installed on the upper side of the window frame; Each rotator (52) is provided at both ends of the head rails (10) to form a pair; on one side of the rotator (52), a hollow portion is formed at the center of the body for freely rotating when the head rail (10) is mounted. A pair of caps (50) has provided an engaging jaw (51b) formed on the outer periphery and a pair of brackets (51) as a mounting means (51a) formed a through hole (51c) therein; A round bar (22) as a kind of a winding member is disposed on the lower side of the head rail (10) and the upper side of the head rail (10) is rotatable. It consists of a screen (20) supported on one side of the round bar.

At one side of the screen (20), a bobbin (21) is coupled so that one side is inserted into the slot formed on the round bar, and the bobbin is inserted into the slot so that the screen is assembled to the round bar (22).

Thereafter, when the round bar (22) rotatably mounted between the head rail (10) and the cap (50) is rotated by the external force or gravity, the blind fabric is wound or loosened (unwinding). The lower end of the screen (20) is closed with the lower bar (30).

On the other hand, a spring clutch (400) using a wrap spring is generally adopted as a clutch that enables braking the winding member not to rotate descending and when the power is applied, the winding member is rotational driving. The clutch stator (401) is in a stopped state (see FIG. 2A).

A clutch stator (401) having a locking hole (401c) formed a female locking groove (401d) is provided at one end (left side in FIG. 1B) of the spring clutch (400) (see the right side of FIG. 2B).

At the same time, the cap (50) is provided a protruded bracket (51) having a mounting means (51a) and a stopping protrusion (51b). (See FIG. 1D)

The mounting hole (401c) is inserted into a mounting means (51a) of a bracket (51) (the left bracket of FIG. 1B) without the rotating member (52) of the brackets (51) of the both caps (50). The clutch stator (401), which is the body of the spring clutch (400), is prevented from free-rotating by the bracket (51) of the cap (50), so that the female locking groove (401d) is caught by the engaging step (51b).

The other end of the spring clutch (400) (right side in FIG. 1B) of the pickup member (404 in FIG. 2A) is inserted into the round bar (22) (see FIG. 1B). The round bar (22) rotatably supports the screen (20).

At the same time, the spring clutch (400) is further included a clutch member (402) and a driving member (403). A manual force generated by a human hand as an external force is transmitted from the operational string (60). The blind fabric of the screen (20) is rotating the round bar (22) by the gravity of the weight. So that, the round bar (22) is braking not to rotate by the gravity of the weight as the external force.

Since such a roll shade and the spring clutch (400) are directly related to the present invention, the technical background will be explained in detail for the person skilled in the art about the problems and the cause, thereof.

First, there are two categories of major defects and A/S in the shades, which is a very important business problem to the industry and those in the business. In the sales stage, the defects and A/S problems are the major factors such as a fabric quality and the cutting quality. In the after-sales stage, most of the problems occur due to the failure of the bracket (51) and the spring clutch (400), which are the mounting means. Particularly, the industry and those skilled in the art are very sensitive to the failure of the using stage, which is the main cause of after-sales service. This is because the additional costs are incurred.

There are two major problems concerning the quality in the using stage of the shade. First, in the case of a plastic material, the problem mainly occurring is the falling of the bracket (51), because it is not able to support the force. In the case of a metal material, the latching jaw (51b) of the bracket is bent without being able to overcome the load.

But, the second of the bigger problem is that a noise or tightness generated in the spring clutch (400). Over the time elapsed, the braking does not working properly and the blind fabric will be descending. The rising or descending of the blind fabric will not be smoothly performed. The main reason is due to the structural problem of the spring clutch (400). This is the problem to be solved by the present invention.

The spring clutch (400) is used a substantially inexpensive wrap spring as a clutch member (402), as shown in FIG. 2A to FIG. 2D.

Such a spring clutch (400) includes that; a clutch member (402) forms a wrap spring integrally formed with engaging portions (402a, 402b); A spring friction surface (401a) is provided on the body, in which the clutch member (402) is fitted and provides frictional force. A clutch stator (401) is provided a mounting hole (401c) formed at one side of the body being fixedly fitted to the supporting means (401b) protruding by a predetermined length and the mounting means (51a) of the bracket (51); a manual pulley (403a) is rotating with a ball chain (60) or a rotating string (not shown); a driving member (403) having a driving rotor (403b) formed on the body and the body integrally or axially formed with the manual pulley (403a) and fitted to the outer peripheral surface of the clutch stator (401); the frictional braking force is increased between the clutch stator (401) and the clutch member (402). And a pickup member (404) having braking engaging means (not shown in FIG. 2A, 404b in FIG. 2C) formed therein.

In addition, it may include a transparent case (4a5) that is mounted on the outer periphery of the manual pulley (403a) and covers of the ball chain (60) or a rotating string (not shown) from the outer periphery.

The driving rotor (403b) of the driving member (403) is released the frictional braking force between the spring friction surface (401a) of the clutch stator (401) and the wrap springs of the clutch member (402) to rotate by pushing in the direction of opening the lap spring body as the clutch member (402) with the spring engaging portion (402a) formed integrally to the spring friction surface (401a) of the clutch member (402).

The pickup member (404) is formed a protruding step (404a) to fit into the round bar (22), so that the inner peripheral surface is coupled to the driving member (403) and the clutch stator (401). The other latching portion (402b) of the clutch member (402) is pushed in the direction in which the lap spring body is narrowed for increasing the frictional braking force between the clutch stator (401) and the clutch member (402).

Therefore, when the user rotates the manual pulley (403a) (the direction indicated by the solid arrow in FIG. 3), which is a constitution of the driving member (403) by a force pulling the ball chain (60) or the rotating string (not shown). The driving rotor (403b) pushes the latching portion (402a) of the clutch member (402) in the direction in which the wrap spring body is opened to release the frictional braking force between the clutch stator (401) and the clutch member (402) by pushing and rotating the braking engagement means (404b) of the pickup member (404). The protruding step (404a) formed on the outer peripheral surface finally rotates the round bar (22) in the rotating direction.

On the other hand, to stop the descending of the fabric screen by the gravity, that is, as a state in which braking is to be performed, if the user stops pulling the ball chain (60) or the rotating string (not shown), or if the fabric screen is normally hanging, a rotational force is applied to the round bar (22) according to the load of the screen (20), this rotational force eventually causes to rotate the pickup member (404). The braking engaging means (404b) of the pickup member (404) pushes in the direction in which the wrap spring body of the clutch member (402) is narrowed (in the direction of the dotted arrow in FIG. 3) by increasing the frictional braking force between the spring friction surface (401a) of the clutch stator (401) and the clutch member (402) (I.e., brakes), the round bar (22) is prevent the descending rotation due to the gravity of the fabric screen.

At this point, the inner diameter of the wrap spring is generally made 0.3 mm to 0.6 mm smaller than the outer diameter of the clutch stator (401). It is very hard to tight fit assembly. The wrap spring is widen when the wrap spring is engaging to the clutch stator (401). The worker's hand is hurt by the engaging portions (402a, 402b) of the clutch member (402) so that the many workers are avoided this works. However, even if this is the case, after the assembly, the lap spring is fitted too tightly to the clutch stator (401). It is so stiff enough to be able to rotate, even if it rotates, it generates a lot of frictional heat. This is a major cause of thermal deformation and wear deformation of the clutch stator (401), which is a plastic material.

Accordingly, the conventional clutch is further applied the lubricants to solve this problem. However, it is well known to those skilled in the art that more rapid thermal deformation and wear deformation occur when the lubricating oil escapes or volatilizes due to gravity over time elapsed. The whole industry has been troubled, and it's still not working out.

Of this state, on the back side of the conventional clutch technology, there is a structural problem as mentioned above that technicians need to solve technically. The applicant has analyzed this problem to help those skilled in the art for understanding it with the briefly explains of the fundamental cause. In order for the wrap spring to fit into the clutch stator (401) and be used for both the braking and driving purposes with the core clutch element, It is natural that the driving rotator (403b) should be placed between the two latching portions (402a, 402b) at both ends of the clutch member (402), so that the diameter of the wrap spring is widened (Since the left and right driving must be performed). The braking engaging means (404b) (not shown in FIG. 2A, not shown in FIG. 2C) of the pick-up member (404) is that when the round bar (22) is rotated by its gravity and should brake the round bar (22), it should be placed and rotated between the engaging portions (402a, 402b) of the clutch member (402), 402b) to narrow the inner diameter of the wrap spring (since the left and right brakes must be performed).

Therefore, the two components of the drive member (403) and the pickup member (404) that the two mechanical elements have different purposes and eventually contradict each other, are interposed between the two engaging portions (402a, 402b) of the clutch member (402), which are spaced apart from each other by a certain number of turns with only a small tolerance and mutually intersected and assembled. When the pickup member (404) and the driving member (403) perform their respective actual operations as intended at different times, there is a root cause in the structure that can cause mutual interference. These interferences are critical to braking, especially when the fabric screen is descending acts as a bottle neck.

More specifically, when the user lowers the fabric screen and stops pulling, the position of the driving rotor (403b) is positioned close to the one-side engaging portion (402a) of the clutch member (402). The pick-up member (404) is pulled by the fabric screen load and pushes one end of the spring tip while rotating, thereby reducing the inner diameter and entering the braking. However, due to cross-assembly it occurs the interference. When the driving rotor (403b) is driven, at the same time, the opposed latching portion (402b) of the clutch member (402), which is located close to the other opposite side, will be widen, each other. As a result, it cannot perform the braking.

On the other hand, right after the user performs the rising drive, the situation is completely different. The reason for this is that right after raising drive; the one side engaging portion (402a) of the clutch member (402) will be opened while raising the sunshade. At the moment of the user stop pulling, the pick-up member (404) is pulled down by the gravity of the fabric screen and automatically rotates reverse direction against the user intend to rotate rising up the fabric screen. As a result, it enters the braking state. Even if the driving rotor (403b) is driven by simultaneous interference, there is no trouble occurred to braking it, right after rising operation. This is because the engaging portion (402b) of the opposite side of the clutch member (402) is spaced apart from the driving rotor (403b) by enough distance. The pickup member (404) pushes as apart distance as the tip of the wrap spring, which is the other engaging portion (402b) of the clutch member (402) to narrow the inside diameter until completely braking. The driving rotor (403b) may interfere with the spring tip, which is the one-side engaging portion (402a) and the driving rotor (403b) will be driven. A malfunction occurs when the driving rotor (403b) is rotating to be pushed by the braking pick-up member (404) until reach the opposite spring tip, which is the one-side engaging portion (402a). There is no malfunction occurs, because it does not touch. As a result, no problem arises in the braking after the ascending drive. For reference, the tip of the wrap spring, which is both engaging portions (402a, 402b) of the clutch member (402) is not arranged at 180 degrees, but arranged at 105 to 150 degrees. The driving rotor (403b) is also formed at about 105 to 150 degrees, so that the malfunctions can be caused only by rotating 60 to 170 degrees.

For example, the braking engaging means (not shown in FIG. 2A, 404b in FIG. 2C) of the pickup member (404) pushes the other side engaging portion (402b) of the clutch member (402). (i.e., the pickup member pushes the opposite tip of the wrap spring.) When attempt to brake by narrowing the inner diameter of the wrap spring, a cross interference will be occurred before the braking is completed, as the above-described. Because the pickup member (404) and the driving member (403) are not structurally independent each other, the pickup member (404) touches the driving member (403), which are abutting against the tolerance level, and rotating a certain portion together. Then, the braking is not completed, because the one-side engaging portion (402a) of the clutch member (402) is opened, unexpectedly. Particularly, this phenomenon is a problem that occurs at the time of descending drive.

However, the industry has not solved this problem fundamentally, to applying the method of shortcut, by tightly fitting the inner diameter of the wrap spring, which made smaller by 0.3 mm to 0.6 mm than the outer circumferential surface of the clutch stator (401). Even if such a mutual interference occurs, the other lap spring tip is made to resist the interfering drive of the driving member (403), and make the pickup member (404) is braking.

However, the conventional spring clutch (400) contains the three noteworthy problems that those skilled in the art recognize its causes. i.e., first, it is stiff enough to drive rotation by the user. Secondly, even if it is rotated, it generates a lot of frictional heat, and if the lubricant is applied to prevent it, the fabric screen is slowly and gradually descending downward (lubricating oil is applied to the brake). Third, the clutch stator (401) made of a plastic material will be deformed easily by the frictional heat and the abrasion. Eventually, this problem causes the defect and leads us costly A/S.

In summary, a pattern of the mutual interference is mainly caused when the pickup member (404) is braking. When the braking is attempted by narrowing the inner diameter of the wrap spring and by the self-weight load of the blind screen, at this moment, the tip of the wrap spring is strongly pressed and rotated, of which the body is twisted due to the nature of the helical shape of the wrap spring, and moving in the all directions of front-rear, up-down and occurring the pattern of interference. i.e., when the blind screen is driven, the round bar (22) rotates and moves up-down and left-right (oscillates in the axial and vertical directions). It shows a pattern of advance-retract moving in the axial direction. It is easily to understand for those skilled in the art that the pickup member (404) is affected to interference with the driving motor (403b) due to the oscillation of the up-down and left-right. Among them, it is relatively easy to control the pattern of interference in the axial direction, but it is a very difficult problem to prevent mutual interference from the oscillation of the up-down and left-right as mentioned above for the crossing structural situation.

Meanwhile, those skilled in the art will appreciate that in order to alleviate the underlying structural problem of the spring clutch (400), the inner diameter of the wrap spring makes about 0.1 mm˜0.2 mm larger than the outer diameter of the clutch stator (401). An attempt has been made to increase the frictional force with the wrap spring by widening the inner diameter of the wrap spring applied to the normal clutch and adopting the metal material to the clutch stator (401). However, since the clutch stator (401) is made of a metal material, at this time, the wrap spring is rotating on the outer periphery of the clutch stator (401); so that a “rolling noise” is generated (a sound is generated even when the lubricant is applied). It is practically impossible to apply the metal material. (the “rolling noise” is fatal at the home).

Also, in order to solve this problem, the planetary gear set is further adopted in such a manner as to be integrated with or coupled to the driving motor (403b), as shown in FIG. 2D. The planetary gear set includes a ring gear (403d), a planet gear (403c) and a sun gear (403f) by applying a combination having a reduction gear ratio. Also, it is alleviated the problem of pulling force for the user, even if the wrap spring is tightly fitted, so that the user is allowed to drive with a small force. At the same time, when a metal material is applied, the rotating speed of the wrap spring on the outer periphery of the clutch stator (401) is reduced. A technical method is applied to minimize the generation of “rolling noise”. When the plastic material is applied, the rotation number of the wrap spring is reduced to minimize the occurring of abrasion or frictional heat. However, the problem of the interference cannot be fundamentally prevented between the driving member (403) and the pickup member (404).

In addition, some of those skilled in the art will restrict the turning member of the wrap spring within the thickness of the manual pulley (403a). The body of manual pulley (403a) is integrally formed or axially connected to the driving member (403) of the driving motor (403b) to prevent the oscillation. However, the interference occurred in the axis direction between the driving member (403) and the pick-up member (404) cannot be prevented. In addition, in this case, the braking force is not sufficient because the turning number of the wrap springs is small. But, they have limited to apply only the lightweight blinds.

For example, such a conventional spring clutch (400) is integrally formed one body of the wrap spring as a mechanical element and performed the braking and driving simultaneously. It is very easy to manufacturing. Most of all, it costs cheap, so that it is mostly used in the hoist devices, such as a sun-shades and laundry drying devices. As mentioned above, there was a big problem.

Even though the above mentioned problems are not solved at present, some of those skilled in the art are applied a motor. As a result, it costs too expensive and in another aspect, the motor as an electronic device causes a lot of A/S. The numerous those skilled in the art are encountered in great difficulty. An alternative solution is required to solve this problem.

### SUMMARY OF THE INVENTION

Accordingly, the present invention is invented in view of the aforementioned problems of the prior art as described above; an objective of the present invention is to provide a hoist device having an economical, robust and durable brake and smoothly operating clutch module by using a material for compact and easy to manufacturing.

A clutch module for a hoist device according to one aspect of the present invention includes: a manual pulley rotated by an external force; a first clutch member provided the engaging portion being integrally formed with a wrap spring as a body; a clutch stator is fixed to the bracket, which has a first spring frictional surface fitted into the first clutch member for providing a frictional force; a first driving rotor as a driving member provides when the clutch is rotated by the rotation of the manual pulley, the engaging portion of the clutch member is pushed in the opening direction with the body of the wrap spring as the clutch member to release the frictional braking force between the spring friction surface of the clutch stator and the inner diameter of the wrap spring;

when the rotational force of the driving member is transmitted to the power transmitting portion of the hoist device, conversely, transmits from the rotational force of the power transmitting portion of the hoist device, a pickup member increases the friction braking force between the clutch stator and the clutch member by pushing the engaging portion of the clutch member in the narrowed direction with the body of the wrap spring of the clutch member; the interfere preventing means is provided to prevent the unnecessary interference between the driving member and the pickup member, and to prevent the phenomenon of weakened braking force due to the unnecessary interference when the rotational force of the power transmitting portion of the hoist device is transmitted to the pick-up member.

Preferably, a second clutch member is further provided that another wrap spring formed integrally as a body with the engaging portion being fitted to the second spring friction surface of the clutch stator; the second clutch member, there is no effect when the rotational force of the driving member is transmitted to the power transmitting portion of the hoist device through the pick-up member, conversely, when the rotational force of the power transmitting portion of the hoist device is transmitted to the pick-up member of the pick-up member, the body of the wrap spring of the second clutch member is moved to narrowing direction to increase the frictional braking force between the clutch stator and the second clutch member. Thereby, the braking operation will be activated.

Preferably, A second drive rotor is provided that; while the hoist machine is driven, being rotating with the manual pulley, the engaging portion formed integrally with the second clutch member as a body is pushed in the opening direction to release the frictional braking force between the second spring friction surface of the clutch stator and the wrap spring serving as the second clutch member.

More preferably, when the second driving motor formed on the manual pulley is driven by pushing against the rotation of an one-side engaging portion formed on the second clutch member, simultaneously driven by the second clutch member other than driven by an external force, the engaging portion formed integrally as a body with the second clutch member is pushed in the narrowed direction to increase the frictional braking force between the second spring friction surface of the clutch stator and the wrap spring as the second clutch member. A slip braking rotor is further provided to brake the body despite a malfunction of the first clutch member.

Also preferably, the first driving rotor is integrally formed as a body on the driving member and the second driving rotor are integrally formed as a body in the manual pulley.

Also preferably, the clutch stator includes a clutch stator core fixed to a bracket, and a stationary auxiliary means coupled to an outer side of the clutch stator core and having a first spring frictional surface on an outer surface thereof.

Further preferably, the first separating means is provided to prevent a rotational interference interposed between the pick-up member and the driving member:

Also preferably, the second separating means is provided to prevent the rotational interference interposed between the driving member and the manual pulley:

According to another aspect of the present invention, a hoist device is provided the hoist machine including the clutch module.

### EFFECT OF THE INVENTION (INDUSTRIAL APPLICABILITY)

The clutch module and the hoist device applying the same according to the present invention has merits of the enhanced braking and smooth operation, as well as easy producing for compact, favorable gear ratio, robustness and low manufacturing cost.

Further objectives and effects of the present invention will become more apparent from the following detailed description of the present invention when taken in conjunction with the accompanying drawings.

### BRIEF DESCRIPTION OF THE DRAWINGS

FIGS. 1A and 1B are a perspective view and an exploded perspective view of a conventional roll sheeting, respectively.

FIG. 1C is a perspective view of a combination blind, which is a kind of roll shade using two layers.

FIG. 1D is a perspective view of a plastic bracket that is a kind of various brackets assembled in a roll shade.

FIG. 2A shows an exploded perspective view of a conventional roll-type clutch.

FIG. 2B is an example of clutches for various rolls.

FIG. 2C is an exploded perspective view of the real photo clutch shown in FIG. 2B.

FIG. 2D is an exploded perspective view of a clutch for deceleration rolls using a conventional planetary gear.

FIG. 3 is a cross-sectional view of a conventional roll blind, which shows a combined state of roll-type sunshade.

FIG. 4A is a perspective view of a braking and driving clutches for various hoist devices according to the first embodiment of the present invention.

FIG. 4B is a perspective view of a braking and driving clutches for various hoist devices according to a second embodiment of the present invention.

FIG. 5A is a partially exploded perspective view illustrating the braking and driving clutch for various hoist devices according to a first embodiment of the present invention,

FIG. 5B is a cross-sectional view of the braking and driving clutches for various hoist devices according to the first embodiment of the present invention,

FIG. 5C is a cross-sectional view of the braking and driving clutches for various hoist devices according to a first modification of the first embodiment of the present invention,

FIG. 5D is a partially exploded perspective view of the braking and drive clutches for various hoist devices according to the first modification of the first embodiment of the present invention,

FIG. 5E is a cross-sectional view of the braking and drive clutches for various hoist devices according to the second modification of the first embodiment of the present invention,

FIG. 5F is a partially exploded perspective view of the braking and drive clutches for various hoist devices according to a second modification of the first embodiment of the present invention

FIG. 6A is an exploded perspective view illustrating the braking and driving clutches for various hoist devices according to a second embodiment of the present invention,

FIG. 6B is a perspective view of the braking and driving clutches for various hoist devices according to a second embodiment of the present invention,

FIG. 6C is a sectional view of the braking and driving clutches for various hoist devices according to a modification of the second embodiment of the present invention,

FIG. 6D is an exploded perspective view of the braking and drive clutches for various hoist devices according to a modification of the second embodiment of the present invention.

FIG. 6E is a sectional view of the state in which the manual pulley is driven, and

FIG. 6F is a sectional view of the state in which braking is applied by rotation of the pickup member.

### DETAILED DESCRIPTION OF THE PREFERRED EMBODIMENTS

It should be noted that the same numeral references are used as much as possible in the accompanying drawings, when the same configuration is indicated in the other drawings. Furthermore, the descriptions specifically related to a known function or configuration of the present invention is determined that the gist of the present invention may be unnecessarily blurred, then, the detailed descriptions thereof will be omitted. And, some features shown in the figures may be expanded, reduced or simplified for easy explanation. The drawings and their components are not necessarily drawn to the same scale. Further, the device or the element indicating the direction of the front -rear, left-right, top and bottom are used for facilitating the description of the present invention. Those do not mean that the associated device or element must have a particular orientation. Furthermore, the terms such as first, second, male and female are used for the convenience of description. But it does not imply the relative importance, purpose or order. The details of these things will be easily understood for the person skilled in the art.

Hereinafter, the preferred embodiments according to the present invention will be described in detail with referring to the accompanying drawings. The same numeral references as those in the background art will be used as they are.

However, the accompanying drawings are for easily understanding the contents of the present invention. It is readily apparent to those skilled in the art that the scope of the present invention is not limited to the scope of the accompanying drawings.

### First Embodiment

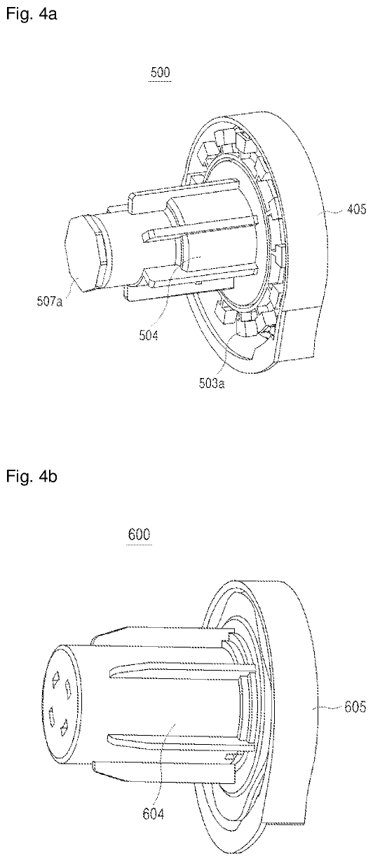

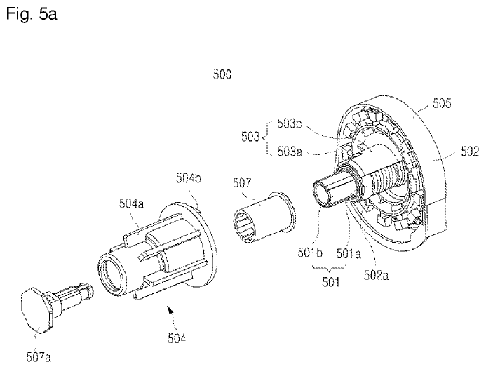

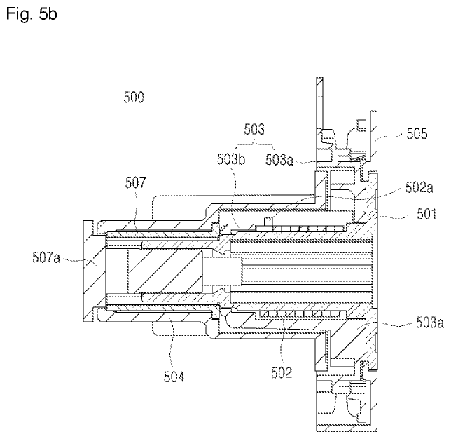

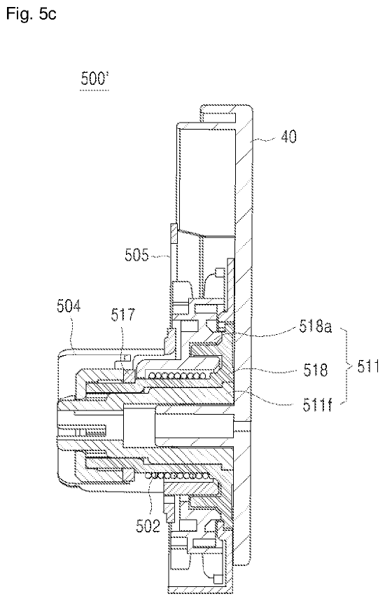

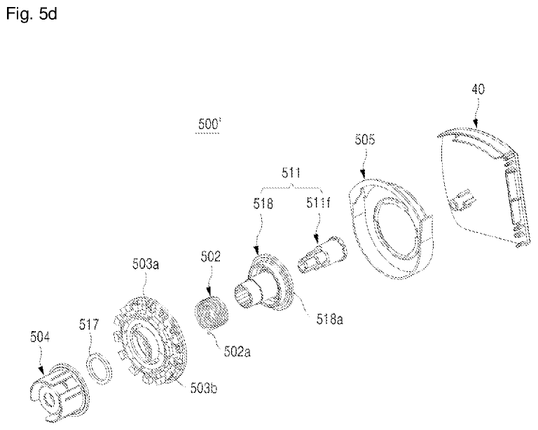

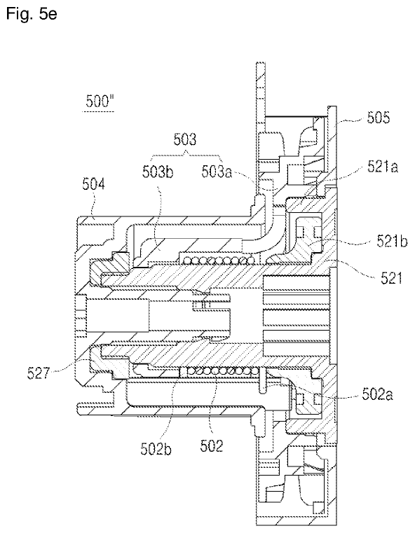

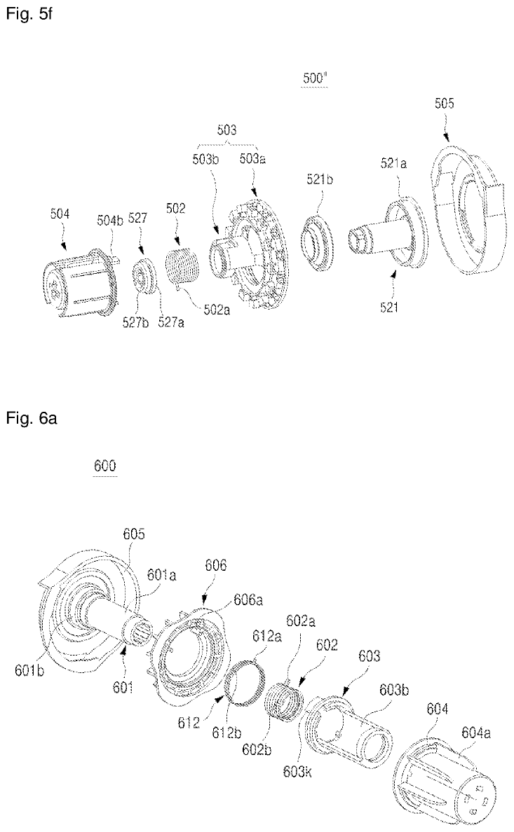

First of all, the braking and driving clutches for the various hoist devices according to the first embodiment of the present invention will be described with referring to FIG. 4A and FIG. 5A to FIG. 5F.

FIG. 4A is a perspective view of a braking and driving clutch for the various hoist devices according to a first embodiment of the present invention. FIG. 5A is a partial exploded view illustrating a braking and driving clutch for the various hoist devices according to a first embodiment of the present invention. FIG. 5B is a cross-sectional view of the braking and driving clutch for the various hoist devices according to the first embodiment of the present invention.

FIG. 5C is a cross-sectional view of a braking and driving clutch for the various hoist devices according to a first modification of the first embodiment of the present invention. FIG. 5D is a partially exploded perspective view of a braking and drive clutch for the various hoist devices according to a first modification of the first embodiment of the present invention.

FIG. 5E is a cross-sectional view of the braking and drive clutch for the various hoist devices according to the second modification of the first embodiment of the present invention. FIG. 5F is a partially exploded perspective view of a braking and drive clutch for the various hoist devices according to a second modification of the first embodiment of the present invention.

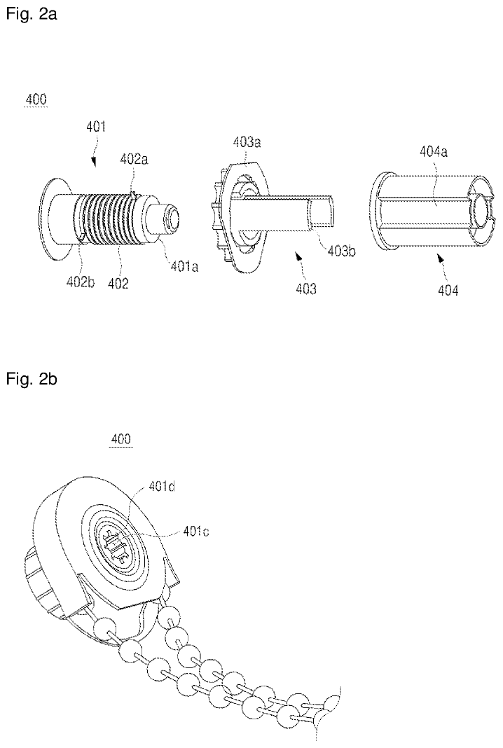

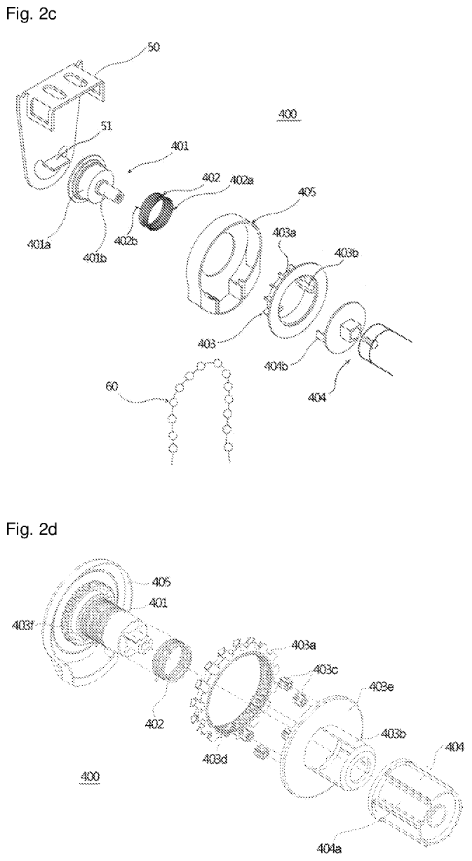

The enhanced braking and smoothly operating clutch module (500) according to the first embodiment of the present invention as shown in FIG. 4A and FIG. 5A to FIG. 5B, a clutch member (502) is provided as a wrap spring integrally formed a body with the engaging portions (502a, 502b); a spring friction surface (501a) is provided on the body to which the clutch member (502) is fitted to provide a frictional force, and a clutch stator (501) is provided a mounting hole (not shown refer to FIG. 2B, 401c) formed on one side of the body fitted firmly on the a mounting means (not shown, refer to 51a in FIG. 10 and FIG. 2A) having a protruded supporting means with preset length and the bracket (not shown, refer to 51 in FIG. 10 and FIG. 2A); a manual pulley (503a) is rotating with a ball chain (not shown, refer to FIG. 2b) or a rotating string (not shown); a driving member (503) is fitted on the outer peripheral surface of the clutch stator (501), in which a drive rotor (503b) is formed on the body, and is formed integrally or axially with the manual pulley (503a); a pick-up member (504) is formed the braking engaging means (504b) for increasing the frictional braking force between the clutch stator (501) and the clutch member (502); a separating means (507) is provided to prevent the interference of up-down or left-right between the pick-up member (504) and the driving member (503). In addition, it may further include a case (505) and covers, which is mounted on the outer periphery of the manual pulley (503a) and rotates with the ball chain (not shown in FIG. 2B) or the rotating string (not shown).

The driving rotor (503b) of the driving member (503) pushes the one engaging portion (for example, 502a) formed integrally with the clutch member (502) in opening direction to rotate the body of the wrap spring as the clutch member (502) by releasing the frictional braking force between the spring friction surface (501a) of the clutch member (501) and the wrap spring inner diameter of the clutch member (502).

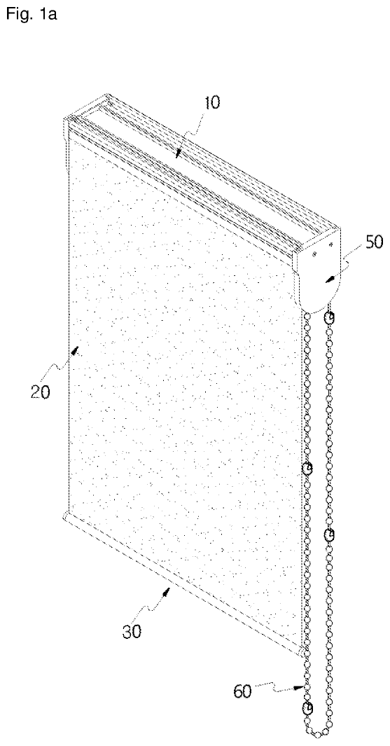

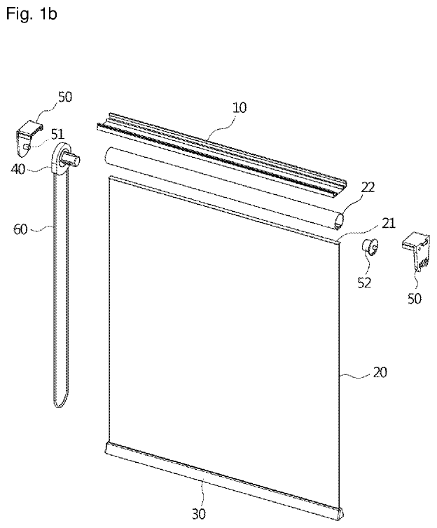

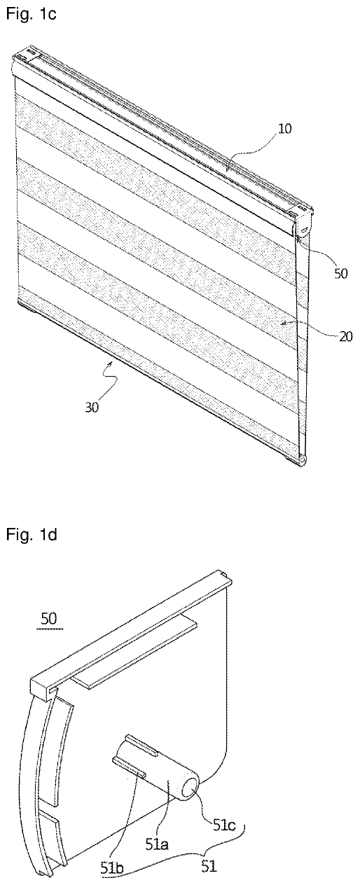

The pick-up member (504) is integrally or separately provided with a protruding step (504a) so that the outer peripheral surface of the body is fitted to a round bar (22 refer to FIG. 1A) and the inner peripheral surface of the body is inserted a bushing and coupled to the clutch stator (501). The frictional engaging force between the clutch stator (501) and the clutch member (502) is increased by pushing the other engaging portion (502b) in the direction to narrow the wrap spring body of the clutch member (502); Here, the one side of the latching part (502a) and the other side of the latching part (502b) may be determined inversely to the ascending/descending direction, and the numeral references are for convenience of explanation.

Preferably, a first fixed engaging means is provided to form on one side of the body of the clutch stator (501); Further, a second fixed engaging means (507a) is tightly fitted to the clutch stator (501); The pickup member (504) and the driving member (503) are stably coupled to the clutch stator (501); The body is formed with a preset length; so that the pick-up member (504) is stably and mounted from behind for rotating; So that the driving member (503) is inserted a bushing and closely coupled to the clutch stator (501) for rotating.

i.e., when the pickup member conventionally brakes, the inner diameter of the wrap spring is narrowed by the self-load of the blind. When the braking is attempted, it is rotated by a predetermined angle. At this time, the tip of the wrap spring is strongly pressed and rotated. The body is twisted due to the nature of the helical wrap spring, and moves in front-rear. However, the separating means (507) of this embodiment is positioned between the pick-up member (504) and the driving member (503). The separation means (507) stably holds a part of the pickup member (504) on its outer periphery while preventing axial interference. It has a feature of preventing interference with the driving member (503) due to oscillation of up-down or left-right of the pick-up member (504) when attempting the braking.

In the first embodiment, a protruding step (504a) is integrally formed as one body on the outer peripheral surface of the pickup member (504) to fit a round rod; either one of the clutch stator (501) or the manual pulley (503a) or the driving member (503) or the pick-up member (504) is selected to include any or all of planetary gear train module.

On the other hand, the clutch module (500) with smooth driving and enhanced braking according to the first embodiment, the inner diameter of the wrap spring serving as the clutch member (502) is made narrower than the diameter of the spring friction surface (501a) of the clutch stator (501); it is wider than a wrap spring used by a normal clutch; It is possible to prepare without lubrication; as the material of the clutch stator (501), it is preferable to use an engineering plastic material having good abrasion resistance and heat resistance.

The reason for this is that, according to the first embodiment, the wrap spring does not responsible to prevent the mutual interference between the driving member (503) and the pickup member (504); the wrap spring is possible to perform the function of braking and driving; even if the inner diameter of the wrap spring is widened and the lubricant is not applied, it is well known to those skilled in the art that the braking frictional force is greater than when the inner diameter of the wrap spring is narrowed and applying a lubricant; since the driving member (503) has been already widened at the time of constructing the inner diameter of the wrap spring, the driving member (503) rotates the engaging portion (502a) of the wrap spring by a preset angle within a limited range; the inner diameter of the wrap spring becomes wider even if it is slightly pushed; so that the frictional force becomes smaller on the outer peripheral surface of the clutch stator (501) and will turn quite smoothly; for reference, in the case of the conventional lap spring is fabricated with a narrow inner diameter because of the above mentioned problem, even if the driving member (503) rotates the latching portion (502a) of the wrap spring by a limited angle, the inner diameter of the lap spring is not sufficiently expanded and it rotates in a very tight state; as a result, the wrap spring can be applied to the outer peripheral surface of the clutch stator (501) for reducing the frictional heat generated due to rotation; thereby, it is possibly reducing the thermal deformation and the wear deformation; In addition, the problem described by the background technique is solved at its fundamental source.

The separating means (507) forms a prolonged body with the predetermined length to prevent the interference primarily between the pickup member (504) with the driving member (503) in the longitudinal direction; the pickup member (504) is mounted on the front and rear sides not to oscillate of up-down right-left when it is operating; it is possible not to interfere the pickup member (504) with the driving member (503) in all axial and vertical directions; or the wrapping number of the wrap spring is made within the thickness of the manual pulley (503a) and the drive rotor (503b) is also formed within the thickness of the manual pulley (503a) and at the same time, the separating means (507) is formed to advance just before the manual pulley (503a); the pickup member (504) and the driving member (503) are mounted, thereon not to interfere, each other.

As a result, in the first embodiment, the body of the separating means (507) is formed with prolonged preset length to stably mount the pickup member (504) not to oscillate in all directions of up-down and left-right, and not to interfere the pickup member (504) with the driving member (503), each other.

According to the first embodiment of the present invention, the clutch module (500) having enhanced braking and smooth operating is consisted of the clutch member (502), the clutch stator (501), the driving member (503), and the pick-up member (504); As the background of the present invention is described in detail and understood readily for those skilled in the art; in this regard, further detailed description will be omitted; instead, the operation of the clutch module (500) with enhanced braking in a smooth manner according to the first embodiment of the present invention, the constructs as described above will be briefly described.

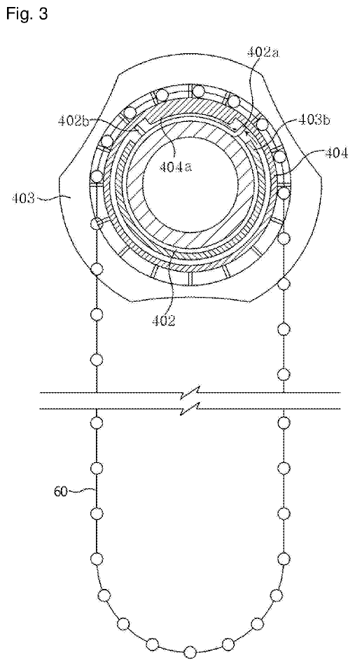

For example, at a time of driving, the user rotates the manual pulley (503a) (a direction indicated by the solid line in FIG. 3) by a force pulling a ball chain (not shown) or a rotating string (not shown); The frictional braking force between the clutch stator (501) and the clutch member (502) is released by pushing the one engaging portion (502a) of the clutch member (502) in the direction to open the wrap spring body; at the same time, the braking engaging means (504b) of the pick-up member (504) is pushed to rotate, the projecting step (504a) formed on the outer peripheral surface pushes the round bar (22) in the rotating direction.

On the other hand, in order to stop the fabric screen from descending by gravity, i.e., state of required braking, when the user stops pulling of the ball chain (not shown) or the rotating string (not shown) or if the fabric screen is hanging normally, the reverse rotating force is activated on the round bar (22) by the gravity of the fabric screen; this rotational force eventually causes the pickup member (504) to rotate in the reverse direction; the braking engaging means (504b) of the pickup member (504) pushes the wrap spring body as the clutch member (502) in the direction to be narrowed (in the direction of the dotted arrow in FIG. 3) to increase the frictional braking force between the spring frictional surface (501a) of the clutch stator (501) and the clutch member (502) and stop the automatic rotation of the rod (22) by the gravity of the fabric screen.

i.e., even if the mechanism for braking is the same as the conventional clutch, the clutch module (500) being enhanced braking and smoothly operating according to the first embodiment of the present invention, the separating means (507) is as one of constitution that the pickup member (504) avoids to touch the drive motor (503b) or the manual pulley (503a) for preventing the mutual interference.

In the first embodiment of the present invention, the various modifications are possible.

i.e., according to the clutch module (500′) of the first modified example as shown in FIG. 5C and FIG. 5D, is provided that; first, the clutch stator core (511f) for mounting the clutch stator (511) to the stopper (40) (518a in FIG. 5A); a mounting auxiliary means (518) having a spring friction surface (refer to 501a in FIG. 5A) on the outer surface and coupled to the outside of the core; the braking engaging means (504b) of the pickup member (504) is inserted deeply into the inner periphery; the mounting assist means (518) of the clutch stator (511) is formed the projected annular portion (518a) in an annular shape.

According to the modified embodiment, the braking engaging means (504b) of the pickup member (504) pushes the wrap spring body as the clutch member (502) in the narrowed direction (in the direction of the dotted arrow in FIG. 3); when the frictional braking force between the spring friction surface of the clutch stator (511) and the clutch member (502) is increased; one end of the braking engaging means (504b) is inserted and positioned inside the mounting assist means (518), It is more preferable that the pickup member (504) is fundamentally blocked the oscillation of up-down and left-right for preventing the interference.

At this time, the mounting auxiliary means (518) is made of a material resist to the abrasion of the wrap spring, which is integrally and fixedly coupled to the clutch stator core (511f).

In the first modified embodiment as shown in FIGS. 5C and 5D, the separating means (517) has a simple shape of a washer without a flange portion as compared with the separating means (507) in FIG. 5A.

On the other hand, as shown in FIG. 5E and FIG. 5F, according to the clutch module (500′) in the second modification of first embodiment of the present invention, the clutch stator (521) may further include a stationary rotating rotor (521b) embedded in the annular groove portion of the clutch stator (521) having the projecting annular portion (521a).

Thus, a combination of the braking engaging means (504b) and the stationary rotating rotor (521b) is providing to limit the braking engaging means (504b) locating inside the clutch stator (521); Of course, it can be prevented that the mutual interference between the driving member (503) and the pick-up member (504); and an additional merit can be provided that the more stably rotation is performed by the stationary rotating rotor (521b).

Furthermore, the separating means (527) in the second modification as shown in FIG. 5E and FIG. 5F, it is possible to have the flange portion (527b) and the washer portion (527a), together.

### Second Embodiment

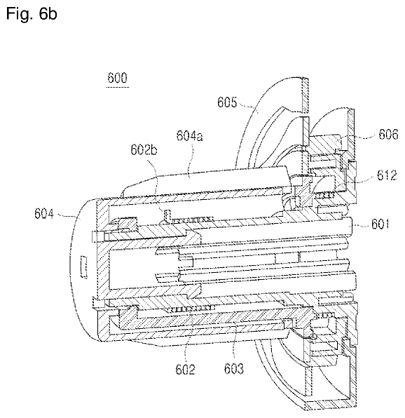

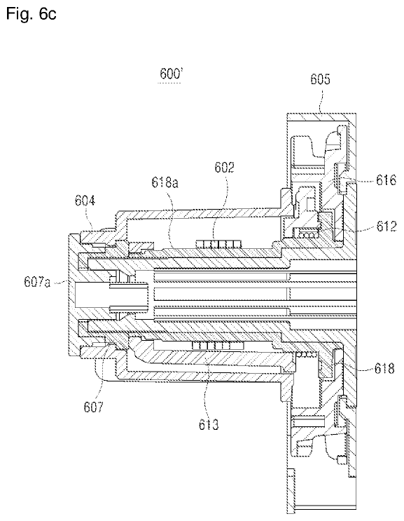

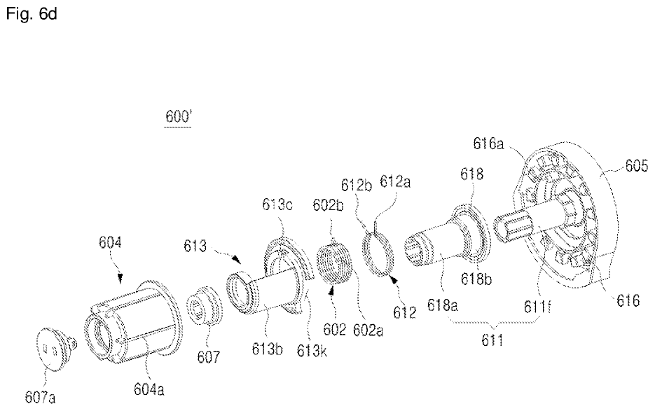

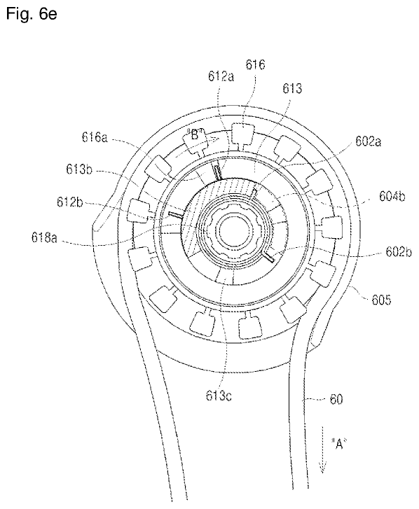

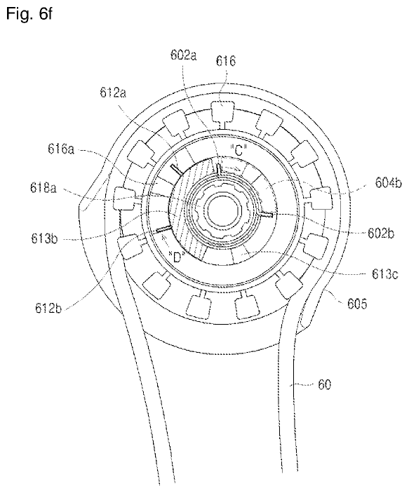

Hereinafter, the braking and the driving clutch for various hoist devices according to the second embodiment of the present invention will be described with reference to FIG. 4B and FIG. 6A to FIG. 6F.

FIG. 4B is a perspective view of a braking and a driving clutch for various hoist devices according to a second embodiment of the present invention.

FIG. 6A is an exploded view illustrating a braking and a driving clutch for various hoist devices according to a second embodiment of the present invention; FIG. 6B is a cross-sectional view of the braking and driving clutch for various hoist devices according to the second embodiment of the present invention.

FIG. 6C is a cross-sectional view of the braking and driving clutch for various hoist devices according to a modification of the second embodiment of the present invention; FIG. 6D is an exploded view of the braking and driving clutch for various hoist devices according to a modification of the second embodiment.

FIG. 6E and FIG. 6F are a cross-sectional view along cutting line VI-VI in FIG. 6C; FIG. 6E is a sectional view of a manual pulley in a driving state; and FIG. 6F is a sectional view in a braking state by rotation of a pickup member.

The biggest difference between the enhanced braking and the smoothly operating clutch module (600) according to the second embodiment of the present invention is that; in addition to the first clutch member (602), which is similar to the clutch member in the first and second embodiments, it further has a second clutch member (612), as shown in FIG. 4B and FIG. 6A and FIG. 6B; further, for convenience of explanation, likewise the first engaging portion (602a) and the second engaging portion (602b) provided at each of both ends of the first clutches (602), the engaging portion being provided at each of both ends of the second clutch (602, 612) in this embodiment will be described separately as the first engaging portion (602a, 612a) and the second engaging portion (602b, 612b); however, this is also distinguished for convenience of explanation, it is a relative concept that can be changed at any time according to the lifting direction of the weight of the hoist machine.

The clutch module (600), which is operated smoothly with enhanced braking according to the second embodiment of the present invention comprises that; a first clutch member (602) is provided with a wrap spring being integrally formed with the first and second engaging portions (602a, 602b); a second clutch member (612) is provided with a wrap spring integrally formed with the first and second engaging portions (612a, 612b); a first spring friction surface (601a) fitted to the body of the first clutch member (602) and a second spring friction surface (601b) fitted to the body of the second clutch member (612) are providing the frictional force; a clutch stator (601) is provided a mounting hole (see 401c of FIG. 2A and FIG. 2B) formed on one side of the body to be fixedly fitted to bracket as the mounting means (refer to 51 in FIG. 10 and FIG. 2A); a manual pulley (606) on which a ball chain (60) or a rotating string (not shown) is hanging to rotate; a driving member (603) fitted to the outer circumferential surface of the clutch stator (601); a first drive rotor (613b) is releasing the frictional braking force between the first spring friction surface (601a) of the clutch stator (601) and the wrap spring as the first clutch member (602) by pushing the lap spring body in the direction to be opened with one side of the engaging portion (602a, 602b) formed integrally with the first clutch member (602), and for rotating; a second drive rotor (606a) is rotating while the manual pulley (606) is rotating together, the engaging portion (612a) formed integrally as one body with the second clutch member (612) is pushed the lap spring body in the direction to be opened to release the friction braking force between the second spring friction surface (601b) of the clutch stator (601) and the wrap springs as the second clutch member (612); the outer peripheral surface of the body is rotationally coupled to the round bar (22), and the inner peripheral surface of the body is rotationally coupled to the driving member (603) and the clutch stator (601), a pick-up member (604) is for increasing the frictional braking force between the clutch stator (601) and the first clutch member (602) by pushing the lap spring body of the first clutch member (602) in the direction to be closed for raising and lowering the hoist device; when the second driving rotor (606a) formed in the manual pulley (606) rotates, which is driven by the first engaging portion (612a, 612b) formed on the second clutch member (612), at the same time, when it is driven by an external force (interference etc.) other than being driven by the second clutch member (612), the engaging portion (612a) formed integrally with the second clutch member (612) is pushed the lap spring body as the second clutch member (612) in the direction to be narrowed, to increase the frictional braking force between the second spring frictional surface (601b) of the clutch stator (601) and the wrap spring as one body of the two clutch members (612), and a slipping stopper (603k) is braking the body of the first clutch member (602) irrespective of the malfunction.

When the pickup member (604) is rotating by itself, i.e., baking to prevent the blind fabric descending due to its gravity, the pickup member (604) is braked (when brake is rotated as tight as the wrap spring), and the slip braking rotor (603k) formed in the driving member (603) pushes the engaging portion (612b) of the wrap spring, which is a component of the second clutch member (612) to be narrowed its inner diameter, so the driving member (603) is forcibly stopped by braking and the pickup member (604) is strongly braked.

As a result, unlike the first embodiment of the present invention, the interference occurred when the pick-up member (604) is tried to braking, further the wrap spring clutching element is separately added in manner of multi-stage cascade, to have a feature that the interference rotation occurred due to the mutual interference between the pickup member (604) and the driving member (603) is forcibly prevented and the pickup member (604) is stably braked.

Additionally, a transparent case (605) is further included to cover the ball chain (60) or the rotating string (not shown), which is mounted on the outer periphery of the manual pulley (606) being rotated.

The first driving rotor (603a) is integrally formed and axially coupled to the driving member (603), which is protruded from one side; the second driving rotor (603a) is integrally formed to one body of the driving pulley (606) as a separate member.

Also, the first spring frictional surface (601a) and the second spring frictional surface (601b) may be separately produced on each body for fitting or integrally formed on one body.

Same as the outer peripheral surface of the body of the pickup member (604), a protruding jaw (604a) is optionally provided either one of integrally formed or separately formed to fit into the round bar (22), and the slip braking rotor (603k) may be optionally provided either one of integrally formed or separately formed with the driving member (603) for rotation.

The inner peripheral surface of the body of the pickup member (604) is engaged with the driving member (603) and the clutch stator (601) and is pushed the lap spring body of the first clutch member (602) in the direction to be narrowed for raising and lowering the fabric screen, by increasing the frictional braking force between the first clutch stator (601) and the first clutch member (602), which a braking engaging means (not shown, see 504b in FIG. 5A) is performed.

The pickup member (604) is provided and integrally formed the protruding step (604a) on the outer peripheral surface to be fitted into the round bar (22); it is possible that the planetary gear train module may be selectively included all or some of the clutch stator (601), the manual pulley (606), the driving member (603) or the pickup member (604); however, since the planetary gear train module is easily understood for those skilled in the art, the detailed description thereof will be omitted.

Meanwhile, a clutch braking module (600′) that operates smoothly with enhanced braking according to a modification of the second embodiment of the present invention will be described with reference to FIG. 6A to FIG. 6F.

First of all, the clutch stator (611) of the clutch module (600′) according to the present modified embodiment is similar to that of the first modified embodiment of the first embodiment that the clutch stator core (611f) is mounted on the plug (40) and coupled to the outside of the core for providing a mounting auxiliary means (618) having a first spring frictional surface (618a in FIG. 6D) and a second spring frictional surface (618b in FIG. 6D); together, a first fixed engaging means is provided on one side of the body of the clutch stator (611), further including a second fixed engaging means (refer to 607a in FIG. 6C and FIG. 6D); through this, the pickup member (604) and the driving member (613) are stably coupled to the clutch stator (611); the body is formed to have a predetermined length so that the pickup member (604) can be stably rotated and mounted the driving member (613) is closely contact with the clutch stator (611) or the transparent case (605) so as to be rotatable, a separating means (607) is optionally provided for originally separating the axial interference between the pick-up member (604) and the driving member (613), as shown in FIG. 6C and FIG. 6D.

The separating means (607) is integrally formed as one body with the second supporting means of the clutch stator (611) of a modified embodiment of the second embodiment of the present invention; if the clutch stator (611) is fitted and provided then, the rotational interference between the drive member (613) and the manual pulley (616) is prevented and It is preferably possible to add the third separating means (see 607 in FIG. 6C and FIG. 6D).

Further, a mounting auxiliary means (618) as another third separation means is integrally formed one body with the selected any one or both of the first spring frictional surface (618a) and the second spring frictional surface (618b); or separately produced or provided to insert the clutch stator core (611f) of the clutch stator (611); the first and second clutch members (602, 612) are inserted to each of the first and second spring frictional surfaces (618a, 618b) and the entire of the mounting auxiliary means (618) as another third separation means is inserted to the first mounting means; and the second driving rotor (616a) and the slip braking rotors (613k) of the driving member (613) are separated not to interfere, each other; Since the slip braking rotor (613k) of the driving member (613) rotates and is braked while the inner diameter of the second clutch member (612) is tightening not to contact with the second driving rotor (616a), It is most preferable to prevent the rotational interference, completely.

At this time, if the winding number of the second clutch member (612) is adjusted that its width does not exceed the width of the manual pulley (616), it is more preferable that the mounting auxiliary means (618), which is the third separating means, can completely remove the interference between the second driving rotor (616a) as the driving member and the slip braking rotor (613k).

However, it is also determined that the specific gist of the second embodiment may be unnecessarily blurred. Thus, the present invention is applied only to the present modification embodiment, and is not provided in the second embodiment of the present invention. Referring to FIG. 6C and FIG. 6D, it will skip because it is easy to understand.

There are detail descriptions in the second embodiment for the first clutch member (602), the second clutch member (612), the clutch stator (611), the manual pulley (616), the transparent case (605), the driving member (613), and the pickup member (604); it is easily understood for those skilled in the art, and further explanation will be omitted.

The components that perform the same or similar functions as those in the other embodiments are denoted by the same or similar numeral references; and a detailed description thereof will be omitted; the numeral reference (613c) denotes a through hole that the engaging portions (602a, 602b) of the first clutch member (602) pass through when the clutch module is assembled.

The rotational direction of the spring of the clutch member as shown in FIG. 6C and FIG. 6D for a modification of the second embodiment is opposite to the rotational direction of the spring of the clutch member as shown in FIG. 6A and FIG. 6B for the second embodiment; therefore, when the second drive rotor releases the tightening of the second clutch member (612) during the driving; in the second embodiment, a part of annular-shape is formed along the inner side edge of the passive pulley (refer to 606a in FIG. 6A); in the modified of the second embodiment, a protruding portion is formed at one point of the inner side edge of the manual pulley (see 616a in FIG. 6D).

Similarly, a slip braking rotor formed on the drive member tightens the second clutch member (612) during braking; in the modified of the second embodiment, a part of annular-shape is formed along the inner side edge of the passive pulley (refer to 613k in FIG. 6D); in the second embodiment, the shape of the projected portion formed at one point of one side edge of the manual pulley (see 603k in FIG. 6A).

Finally, the operating relationship of the clutch module (600, 600′) having the reinforced braking and the smoothly driving according to the second embodiment of the present invention, thus constructed the clutch module, will be described with reference to FIG. 6E and FIG. 6F.

Hereinafter, the operation of the clutch modules (600, 600′) will be described, mainly with reference to the drawings of FIG. 6C to FIG. 6F according to a modified embodiment of the second embodiment.

In FIG. 6E and FIG. 6F, it is assumed that the hoist device is lowered when the right rotating string is pulled down; further, when the left rotating string (not shown) is pulled in FIG. 6E, the hoist device is raised; the problems of the conventional technology is examined, when the driving is stopped during the ascending, it does not occur the problem so much, therefore, the description thereof will be omitted.

First, when the user pulls the ball chain or the rotary string (60) (for example, the right side) (see the arrow “A” in FIG. 6E), one side of the manual pulley (616) is rotated (clockwise in FIG. 6E) (see arrow “B” in FIG. 6E), the second driving rotor (616a) as the driving member is pushed the one side of the engaging portion (612a) of the second clutch member (612) in the direction the lap spring body is opened and to be rotated; at the same time, the slip braking rotor (613k) of the driving member (613) is rotated by pushing; The first driving rotor (613b) provided on the other body side of the driving member (613) is rotated, at the same time, the first drive rotor (613b) of the first clutch member (602) is rotated in the direction to the inner diameter is widened, and is rotated; as a result, the first clutch member (602) is coupled and rotated together to the braking engaging means (604b in FIG. 6E, 504b in FIG. 5A) of the pickup member (604); when the pick-up member (604) is rotated, a round bar (not shown) fixed to the protruding jaws (604a) of the pick-up member is rotated to lower the hoist device.

On the other hand, when the user stops pulling the ball chain or the rotary string (60) on the way, the fabric screen on the hoist device is immediately lowered by the self weight (gravity); This rotation causes to rotate the round bar (not shown) and the pick-up member (604) (see arrow “C” in FIG. 6f); subsequently, the braking engaging means (504b in FIG. 5a, 604b in FIG. 6F) of the pick-up member (604) pushes the second engaging portion (602b) of the first clutch member (602) (in a direction to the inner diameter of the first clutch member is narrowed) to be performed the braking.

However, the braking of the first clutch member (602) is actually activated, at the same time, if the pickup member (604) rotates braking-rotation, even if it has a slight clearance with the drive member, but due to the influence of gravity or the shaking from rotation, the driving member (613) is rotated by interference such as contact or friction with the first clutch member (613); the first engaging portion (602a) of the first clutch member (602) is pushed in the direction to the inner diameter is widened (this is the problem in the prior art), a phenomenon may occur that the weight of the hoist device such as the blind screen is descending down without proper braking.

According to the technology of the second embodiment, the slip braking rotor (613k) formed on the drive member (613) is pushed the second engaging portion (612b) of the second clutch member (612) in the direction to the inner diameter of the second clutch member to be narrowed, the second clutch member (612) is braked (see the arrow “D” in FIG. 6F); the drive member (613) is also prevented from the interference rotation, and then the pick-up member (604) is rotated by pushing the second engaging portion (602b) of the first clutch member (602) in the direction to the inner diameter is narrowed, and the braking operation is performed more reliably.

In summary, the clutch module (600, 600′) with smooth operation and enhanced braking according to the second embodiment of the present invention, the conventional clutch is described in the background art that the configurations and roles are different, apparently; according to the second embodiment of the present invention, the manual pulley (606, 616) and the second drive rotor (606a, 616a) are separated from the drive member (603, 613) by the second clutch member (612); The slip braking rotors (603k, 613k) is selectively and clearly block the interference by the second clutch member (612); where the interference occurred when the pick-up member (604) pushes the first clutch member (602) to brake by narrowing the inner diameter thereof; a separate clutch function is added to the braking.

At the same time, when the user drives the manual pulley (616), the clutching function is configured and linked the second clutch member (612) and the slip braking rotors (603k, 613k); the clutch driving power transmitted to the slip braking rotors (603k, 613k) activates the first drive rotor (603b, 613b) of the drive member (603, 613) to drive the clutch member (602) for lifting or descending the fabric screen.

Therefore, the clutch module of the second embodiment of the present invention is significantly different from the configuration of the conventional clutch, which is simply connected the power; it also has a distinctive feature that the conventional clutch cannot block the rotational interference of the manual pulley (606, 616) and the drive pulley (603, 613) having drive functions, when the pickup member (604) starts braking.

If the separating means (607, 618) is further included between the second driving rotor (606a, 616a) and the slip braking rotors (603k, 613k) of the driving members (603, 613) in the first embodiment, the interference rotation of the second driving rotor (606a, 616a) can be completely blocked when the slip braking rotors (603k, 613k) of the driving members (603, 613) brakes; right after releasing the cord or the ball chain during the descent driving, which has been a problem in the meantime, and when the pick-up member (604) press the one-side engaging portion (612b) of the first clutch member (602) to be narrowed the inner diameter while starts braking, the interference is occurred because the first driving rotor (603b, 613b) of the driving member (603, 613) is positioned close to the other engaging portion (612a) of the first clutch member (602); It is a very useful invention that can solve the problem of the conventional clutch due to the mutual interference between the pickup member (604) and the driving members (603, 613).

Also, according to the second embodiment of the present invention, unlike the first embodiment, it is forcibly and reliably prevented the mutual interference, so that it is not necessary to make narrower inner diameter lap spring of the first clutch member (602), in order to be tightly fitted into the first spring friction surface (601a, 618a) of the clutch stator (601, 611). It has a favorable effect in assembly productivity; according to the second embodiment of the present invention, the clutch module (600, 600′) having enhanced braking and operating smoothly, the inner diameter of the clutch member (602) is only 0.1 mm to 0.2 mm smaller than the outer peripheral surface of the clutch stator (601) while being wider than the ordinary clutch; furthermore, it is not necessary to apply lubricant; however, it is more preferable to use an engineering plastic material having excellent abrasion resistance and heat resistance, as the material of the clutch stator (601).

On the other hand, If no lubricant is applied in state of the inner diameter of the wrap spring is widened, it is well known to those skilled in the art that the braking frictional force is rather larger than the case of the applied lubricant to the narrowed inner diameter of the wrap spring; it is rather soft on the driving because the inner diameter of the lap spring is slightly widened at the production stage; the inner diameter of the lap spring (602a, 602b) of the driving member as a driving member will be wider by slightly pushing while rotating within a limited range; the frictional force on the outer peripheral surface of the clutch stator (401) is basically less than the frictional force by tightening, the rotation is very smoothly; i.e., in case that the inner diameter of the wrap spring is made narrowed and assembled, the driving member (603, 613) rotates the latching portion (602a, 602b) of the wrap spring by limited angle, the inner diameter will not expand sufficiently, and rotating in a very tight state.

As a result, the frictional heat due to the rotation of the wrap spring on the outer peripheral surface of the clutch stator (401) is remarkably reduced; in accordance with the thermal and wear deformation are greatly reduced; If one wants to improve, a plastic material having abrasion resistance and heat resistance is used for the clutch stator (401), it will be blocked the problems more intrinsically.

The foregoing description of the embodiments of the present invention is merely illustrative of the technical idea of the present invention. Further, the various changes and modifications may be made easily by those skilled in the art without departing from the essential characteristics of the present invention. Therefore, the embodiments disclosed in the present invention are intended to illustrate rather than limit the scope of the present invention. The scope of the technical idea of the present invention is not limited by these embodiments. It is intended that the present invention cover the modifications and variations of this invention provided they come within the scope of the appended claims and their equivalents.

What is claimed is:

1. A clutch module for the hoist devices comprising:
A rotating body rotated by an external force;
A first clutch member provided with a wrap spring integrally formed with the engaging portion;
A clutch stator fixed to the bracket having a first spring frictional surface fitted to the first clutch member for providing a frictional force;
A driving member including a first driving rotor for releasing the frictional braking force between the spring frictional surface of the clutch stator and the inner diameter of the wrap spring as the first clutch member, while rotated by rotation of the rotating body, by pushing the engaging portion of the first clutch member in the direction to be opened the body of the wrap spring as the first clutch member;
A pickup member for increasing the frictional braking force between the clutch stator and the first clutch member by pushing the engaging portion of the first clutch member in the direction to be narrowed the wrap spring body of the first clutch member, while the rotational force of the driving member is transmitting to the power transmitting portion of the hoist device, conversely, the force is transmitted from the rotational force of the power transmitting portion of the hoist device; and
An interference preventing means for preventing the phenomenon of decreasing the braking force due to the unnecessary interference between the driving member and the pickup member occurred while the rotational force of the power transmitting portion of the hoist device is transmitted to the pick-up member.

2. The clutch module for the hoist devices according to claim 1, comprising that:
A second clutch member provides another wrap spring integrally formed with the engaging portion to be fitted into the second spring frictional surface of the clutch stator; and
wherein, the second clutch member, which is not effected while the rotational force of the driving member is transmitting to the power transmitting portion of the hoist device through the pick-up member, conversely, the rotational force of the power transmitting portion of the hoist device is transmitted to the pick-up member, the wrap spring body of the second clutch member is pushed in a direction to be narrowed the pick-up member to increase the frictional braking force between the clutch stator and the second clutch member for braking.

3. The clutch module for the hoist devices according to claim 2, comprising that;
wherein, the second driving rotor is for releasing the frictional braking force between the second spring friction surface of the clutch stator and the wrap spring of the second clutch member by pushing the engaging portion formed integrally with the second clutch member in the direction the wrap spring body is opened while the hoist device is driving.

4. The clutch module for the hoist devices according to claim 3, comprising that:
wherein the rotating body formed on the second driving rotor is rotated, and is driven by a one-side the engaging portion formed on the second clutch member, at the same time, driven by the second clutch member beside driven by the external force; by pushing the engaging portion formed integrally to the second clutch member in the direction the lap spring body as the second clutch member narrowed for increasing the frictional braking force between the second spring frictional surface of the clutch stator and the wrap spring as the second clutch member to brake the body in spite of the malfunction of the first clutch member.

5. The clutch module for the hoist devices according to claim 3, comprising that:
wherein, the first driving rotor is integrally formed on the driving member and the second driving rotor is integrally formed on the rotating body.

6. The clutch module for the hoist devices according to claim 1, comprising that:
wherein, the clutch stator includes a clutch stator core fixed to the bracket, and a first spring frictional surface on the outer surface of the clutch stator core, and consisting of auxiliary mounting means.

7. The clutch module for the hoist devices according to claim 1, comprising that: wherein, the first separating means interposed between the pick-up member and the driving member for preventing the rotational interference.

8. The clutch module for the hoist devices according to claim 1, comprising that: wherein, the second separating means interposed between the driving member and the rotating body for preventing the rotational interference between the driving member and the rotating body.

9. The clutch module for the hoist devices according to claim 1, comprising that:
wherein, the hoist device is including the clutch module.
